(19) United States
(12) Patent Application Publication
(10) Pub. No.: US 2015/0310367 A1
(43) Pub. Date: Oct. 29, 2015

(54) SYSTEMS AND METHODS DETERMINING A BIT TRIPPING SCHEDULE AND BIT SELECTION BASED ON TOTAL COST OF DRILLING

(71) Applicants: Andrea Kuesters, Brixton (GB); John Wingate, Kew (GB); Riaz Israel, Virginia Water (GB); Colin Cockburn, Esher (GB)

(72) Inventors: Andrea Kuesters, Brixton (GB); John Wingate, Kew (GB); Riaz Israel, Virginia Water (GB); Colin Cockburn, Esher (GB)

(21) Appl. No.: 14/696,718

(22) Filed: Apr. 27, 2015

Related U.S. Application Data
(60) Provisional application No. 61/984,438, filed on Apr. 25, 2014.

(51) Int. Cl. G06Q 10/06

(52) U.S. Cl. CPC G06Q 10/06312; G06Q 10/06313

(57) ABSTRACT

Some embodiments of a method for optimizing drilling include determining at least one section of a wellbore for which to determine a schedule for replacing one or more drill bits during drilling the wellbore. Some embodiments of the method also include determining one or more constraints on the schedule for replacing the one or more drill bits. Some embodiments of the method also include determining, based on the one or more constraints, a plurality of scenarios for replacing the one or more drill bits during drilling the at least one section. Some embodiments of the method include determining, by one or more processors, a total cost for each scenario in the plurality of scenarios. Some embodiments of the method include identifying at least one scenario in the plurality of scenarios that has the lowest cost compared to other ones of the plurality of scenarios.

### CROSS-REFERENCE TO RELATED APPLICATIONS

This application claims benefit of U.S. provisional patent application Ser. No. 61/984,438 filed Apr. 25, 2014, which is hereby incorporated herein by reference in its entirety.

### BACKGROUND

1. Field of the Invention

This disclosure relates generally to methods and systems for resource exploration and production, for example, hydrocarbon exploration and production.

2. Background of the Invention

In resource exploration, a drill bit is utilized to drill a well to extract resources from the earth. Drill bit interaction with abrasive rock in a wellbore and impact damage due to vibrations causes cutters of the drill bit to degrade. This results in a slower rate of penetration (ROP) than with a new bit with sharp cutters. Typically, an operator has to decide whether or not to take the time to pull the drill bit out of the wellbore and change it for a new one. Delaying this decision or making a sub-optimal decision of when to pull the bit can add to the overall cost of drilling the well.

The most basic way to make the decision to pull the drill bit is using solely the operator's experience. Human decision, however, may be subjective and inconsistent, especially in a complex section with multiple bit runs. As a result, cost per foot calculations may be introduced to aid the decision when to pull a drill bit. The cost per foot calculations represent a cost of the drill bit over an amount of wellbore that has been drilled. At the start of drilling with a new bit, the cost per foot is relatively large due to the initial cost of the bit and the small footage drilled. The cost per foot then decreases with drilling time until it reaches a minimum, if left in the hole for sufficiently long. This indicates a decrease in ROP but may not be the first decrease in ROP. This minimum can be used as an indication to change the bit. The increase, however, in cost per foot after the local minimum can be caused by any reduction in ROP, including for example a decrease in ROP due to a formation change (a change in the material being drilled). Hence using cost per foot is not enough to make a well informed decision of when to change a drill bit.

Another method to evaluate whether to replace a bit (“bit trip”) is advised is to compute the cost of using the current bit for a given length and comparing that to the cost of changing the bit and then drilling that length with the fresh bit. This method is more objective and gives a good indication of the most economical choice. This method, however, only considers a single future bit run. As most wells have multiple bit runs and additional constraints, such as the bearing life limit of tricone bits, this method can lose accuracy over an entire well.

Consequently, there is a need for methods and systems that considers all these factors and optimizes bit runs and the bit strategy for an entire well.

### BRIEF SUMMARY

These and other needs in the art are addressed in one embodiment by a method for optimized drilling. The method includes determining at least one section of a wellbore for which to determine a schedule for replacing one or more drill bits during drilling the wellbore. The method also includes determining one or more constraints on the schedule for replacing the one or more drill bits. The method also includes determining, based on the one or more constraints, a plurality of scenarios for replacing the one or more drill bits during drilling the at least one section. Additionally, the method includes determining, by one or more processors, a total cost for each scenario in the plurality of scenarios. The method includes identifying at least one scenario in the plurality of scenarios that has the lowest cost compared to other ones of the plurality of scenarios.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A is a generic diagram that illustrates a land-based example of a drilling system, according to various implementations.

FIG. 1B is a generic diagram that illustrates an offshore example of a drilling system, according to various implementations.

FIG. 2A is a generic block diagram that illustrates an example of a computer system that can be utilized to perform processes described herein, according to various implementations.

FIG. 2B is a generic block diagram that illustrates input and outputs for a bit trip calculator, according to various implementations.

FIG. 3A is flow diagram that illustrates an example of process for optimizing bit tripping, according to various implementations.

FIG. 3B is flow diagram that illustrates a more detailed example of a process for optimizing bit tripping, according to various implementations.

FIG. 4 is a generic diagram that illustrates an example of an output of the bit trip calculator, according to various implementations.

### NOTATION AND NOMENCLATURE

Certain terms are used throughout the following description and claims to refer to particular system components. This document does not intend to distinguish between components that differ in name but not function.

In the following discussion and in the claims, the terms “including,” “includes,” “having,” “has,” “with,” “comprising,” and “comprises” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct connection, or through an indirect connection via other devices and connections. As used herein, the terms “one or more of” and “at least one of” with respect to a listing of items such as, for example, A and B, means A alone, B alone, or A and B. Further, unless specified otherwise, the term “set” should be interpreted as “one or more.”

### DETAILED DESCRIPTION OF THE PREFERRED EMBODIMENTS

According to embodiments described herein, a bit trip calculator can provide a recommendation for pulling up a drill string and replacing a drill bit when drilling a wellbore. The bit trip calculator can, for one or more sections or intervals of the wellbore being drilled, simulate different scenarios for a number of drill bits used and the amount each drill bit is used (e.g. duration, length used, amount used for each section, etc.). For each simulated scenario, the bit trip calculator can determine a total cost for the simulated scenario. In determining the total cost, the bit trip calculator can consider individual costs of various aspects of drilling. For example, the total cost can include the cost of the bits, the cost of other components of the drilling system, the cost of the rig during drilling, the cost of the rig during “tripping” (pulling up the drill string to replace the drill bit and subsequently lower it again). The bit trip calculator can determine the total cost for different simulated scenarios, and then rank the different simulated scenarios to determine, for each section or interval, the simulated scenario with the lowest total cost. In determining the different simulated scenarios, the bit trip calculator can also consider other factors that may exclude different simulated scenarios, such as safety, regulatory compliance, events occurring in the well that prevent drilling, etc.

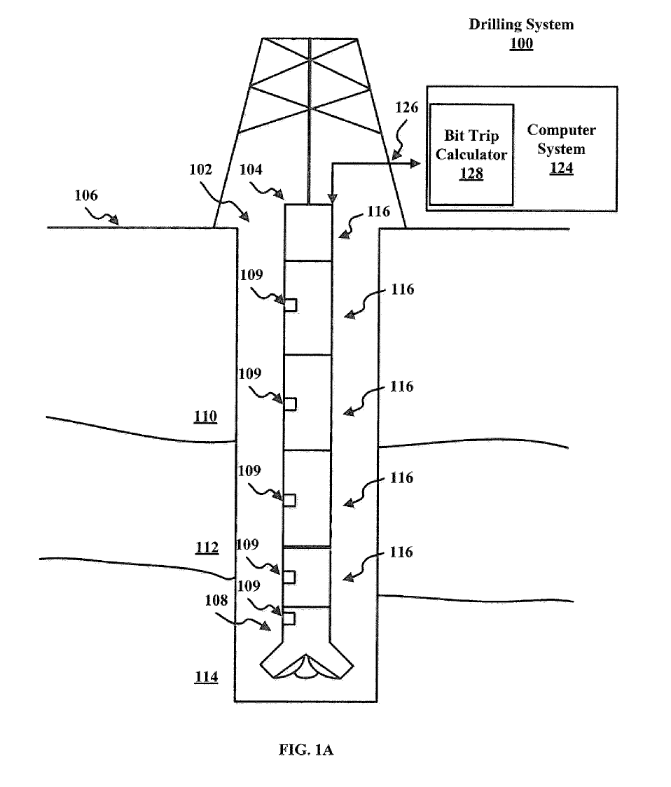

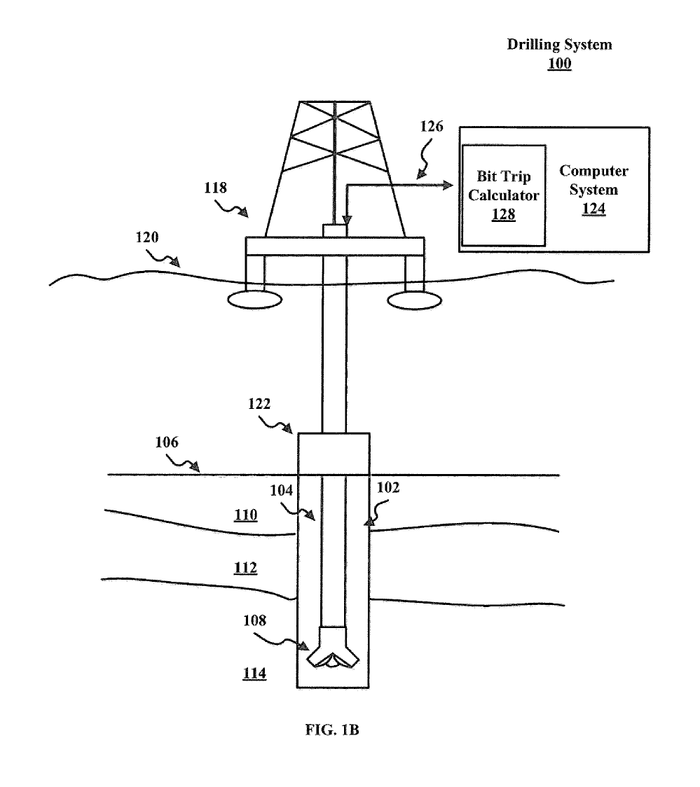

Turning to an example, FIG. 1A illustrates a land-based example of a drilling system 100 for drilling boreholes or wellbores for use in resource production, according to various implementations. While FIG. 1A illustrates various components contained in the drilling system 100, FIG. 1A is one example of a drilling system and additional components can be added and existing components can be removed.

As illustrated, a wellbore 102 can be created utilizing a drill string 104 having a drilling assembly conveyed downhole by a tubing. The wellbore 102 can be utilized to extract resources from the earth 106. The resources can include hydrocarbon (e.g. oil, gas, etc.), water, and the like. As illustrated, the drill string 104 can be utilized to create a vertical wellbore 102. The drill string 104, however, can be used in vertical wellbores or non-vertical (e.g. horizontal, angled, etc.) wellbores. The drill string 104 can include a bottom hole assembly (BHA) 108, which can include a drill bit.

As illustrated, the earth 106 can be composed of a variety of layers 110, 112, and 114, called formations. The layers 110, 112, and 114 can be composed of different combinations of material, for example, rock, dirt, sand, etc. The rate at which the BHA 108 penetrates the earth 106 can amongst other aspects be dependent upon the different combinations of materials within the layers 110, 112, and 114. As illustrated, the tubing of the drill string 104 can include multiple sections 116. During drilling, as the BHA 108 penetrates deeper into the earth 106, additional sections 116 are added to the tubing to allow the drill string 104 to extend further into the earth 106.

The BHA 108 can include variety of drilling sensors 109. The drill string 104 can also include a variety of drilling sensors 109 along its length for determining various downhole conditions in the wellbore 102. The drilling sensors 109 can include any type commonly-used sensors for measuring various properties. The properties include without limitation, drill string pressure, annulus pressure, drill string temperature, annulus temperature, etc. In certain implementations, more specialized sensors can be employed for sensing specific properties of downhole fluids. Such sensors can detect for example without limitation, radiation, fluorescence, gas content, or combinations thereof. For example, the drilling sensors 109 can include without limitation, pressure sensors, temperature sensors, gas detectors, spectrometers, fluorescence detectors, radiation detectors, rheometers, or combinations thereof. Likewise, in implementations, the drilling sensors 109 can also include sensors for measuring drilling fluid properties such as, without limitation, viscosity, flow rate, fluid compressibility, pH, fluid density, solid content, fluid clarity, and temperature of the drilling fluid at two or more downhole locations. The drilling sensors 109 can be placed on the drill string 104 and within the wellbore 102, itself, depending on the type of conditions monitored, the type of data collected, and the processes used to analyze the data. The drilling sensors 109 can be positioned so that the sensors are concentrated in the open hole. The open hole consists of the area of the wellbore 102 that does not include a casing. In implementations, the drilling sensors 109 can be positioned so that the sensors are biased towards the open hole with some coverage within the casing. The drilling sensors 109 can be positioned so that the sensors are evenly distributed within the wellbore 102.

FIG. 1B illustrates an offshore example of the drilling system 100 for drilling boreholes or wellbores for use in resource production, according to various implementations. While FIG. 1B illustrates various components contained in the drilling system 100, FIG. 1B is another example of a drilling system and additional components can be added and existing components can be removed. Those components of the offshore drilling system 100 that are the same as the land-based example share the same reference numbers.

As illustrated in FIG. 1B, the drill string 104 can be supported by a drilling rig 118. The drilling rig 118 can be designed to float on the surface of a body of water 120, for example, lake, sea, ocean, etc. The drilling system 100 can also include a blowout preventer (BOP) 122. The BOP 122 can be placed at the top of the wellbore 102 to prevent material within the wellbore, for example, drilling mud, water, hydrocarbons, etc., from escaping into the surrounding environment. The BOP 122 can be configured to allow the drill string 104 to pass through the BOP 122 into the wellbore 102. While not illustrated, the land-based example of the drilling system 100 in FIG. 1A can also include a BOP 122.

In either example illustrated in FIG. 1A and FIG. 1B, the drilling system 100 can include a computer system 124. The computer system 124 can be configured to assist in the drilling process. For example, data from the drilling sensors 109 can be processed downhole and/or at the surface by the computer system 124. As illustrated, the computer system 124 can be coupled to the drilling sensors 109 by a wire connection 126. Likewise, the computer system 124 and the drilling sensors 109 can be configured to communicate using wireless signals and protocols. Corrective actions can be taken based upon assessment of the downhole measurements, which may require altering the drilling parameters, altering the drilling fluid composition, altering the drilling fluid pump rate or pausing the operation to clean the wellbore. The drilling system 100 contains one or more models, which may be stored in memory downhole or at the surface. These models are utilized by a downhole computer system and/or the computer system 124 to determine desired drilling parameters for continued drilling. The drilling system 100 can be dynamic, in that the downhole sensor data can be utilized to update models and algorithms in real time during drilling of the wellbore 102 and the updated models can then be utilized for continued drilling operations. Likewise, the computer system 124 can utilize measurements from the drilling sensors 109 to determine conditions in the wellbore 102.

In either example illustrated in FIG. 1A and FIG. 1B, the rate at which the BHA 108 penetrates the earth is partially determined based on the material within the layers 110, 112, and 114. Additionally, rate of penetration (ROP) is also based on other aspects including but not limited to the wear state of the drill bit within the BHA 108. As the drill bit within the BHA 108 is used over time, the drill bit begins to wear and cannot destroy rock from the formations as effectively. Eventually, the drill bit within the BHA 108 is replaced with a new drill bit. This requires the drill string 106 and the BHA 108 to be removed from the wellbore 102 and the drill bit replaced. An important aspect of the drilling process is selecting appropriate times when the drill string 106 should be removed and the drill bit replaced.

In implementations, the drilling system 100 can include a bit trip calculator 128 to provide a recommendation for pulling up the drill string 106 and replacing the drill bit. The bit trip calculator 128 can be configured, for each section of the wellbore 102 being drilled, to simulate different scenarios for a number of drill bits used and the amount each drill bit is used (e.g. duration, length used, amount used for each section, etc.). For each simulated scenario, the bit trip calculator 128 can be configured to determine a total cost for the simulated scenario. In determining the total cost, the bit trip calculator 128 can consider the cost of every aspect of drilling. For example, the total cost can include the cost of the bits, the cost of other components of the BHA 108, the cost of the rig during drilling, the cost of the rig during “tripping” (pulling up the drill string to replace the drill bit and subsequently lower it again). The bit trip calculator 128 can determine the total cost for different simulated scenario, and then rank the different simulated scenarios to determine, for each section, the simulated scenario with the lowest total cost. In determining the different simulated scenarios, the bit trip calculator 128 can also consider other factors that may exclude different simulated scenarios, such as safety, regulatory compliance, events occurring in the well that prevent drilling, etc. For example, the bit trip calculator 128 can exclude any simulated scenarios that require the drill string to be in the wellbore 102 longer than a defined maximum time between BOP tests.

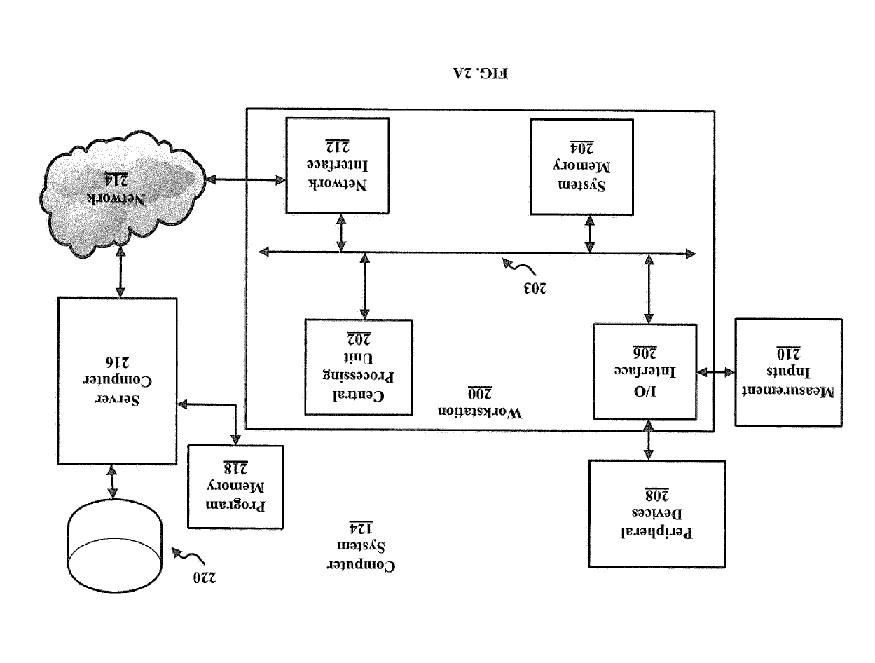

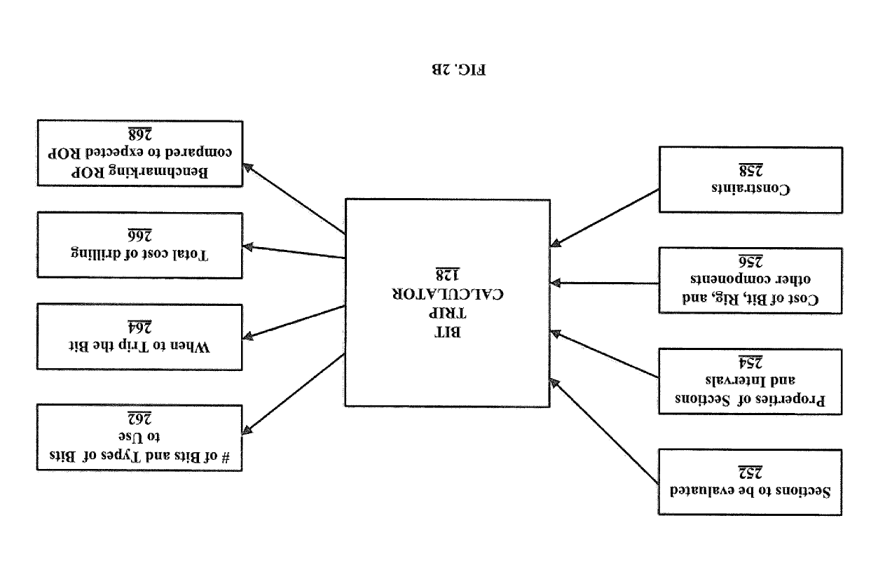

FIG. 2A illustrates an example of the computer system 124, which can operate the bit trip calculator 128, according to various implementations. As illustrated, the computer system 124 can include a workstation 200 connected to a server computer 216 by way of a network 214. While FIG. 2A illustrates one example of the computer system 124, the particular architecture and construction of the computer system 124 can vary widely. For example, the computer system 124 can be realized by a single physical computer, such as a conventional workstation or personal computer, or by a computer system implemented in a distributed manner over multiple physical computers. Accordingly, the generalized architecture illustrated in FIG. 2A is provided merely by way of example.

As shown in FIG. 2A, the workstation 200 can include a central processing unit (CPU) 202, coupled to a system bus (BUS) 203. An input/output (I/O) interface 206 can be coupled to the BUS 203, which refers to those interface resources by way of which peripheral devices 208 (e.g., keyboard, mouse, display, etc.) interface with the other constituents of the workstation 200. The CPU 202 can refer to the data processing capability of the workstation 200, and as such can be implemented by one or more CPU cores, co-processing circuitry, and the like. The particular construction and capability of the CPU 202 can be selected according to the application needs of the workstation 200, such needs including, at a minimum, the carrying out of the processes described below, and also including such other functions as can be executed by the computer system 124. A system memory 204 can be coupled to BUS 203, and can provide memory resources of the desired type useful as data memory for storing input data and the results of processing executed by the CPU 202, as well as program memory for storing computer instructions to be executed by the CPU 202 in carrying out the processes described below. Of course, this memory arrangement is only an example, it being understood that system memory 204 can implement such data memory and program memory in separate physical memory resources, or be distributed in whole or in part outside of the workstation 200. Measurement inputs 210 that can be acquired from different sources such as the drilling sensors 109 can be input via I/O interface 206, and stored in a memory resource accessible to the workstation 200, either locally, such as the system memory 204, or via a network interface 212.

The network interface 212 can be a conventional interface or adapter by way of which the workstation 200 can access network resources on the network 214. As shown in FIG. 2A, the network resources to which the workstation 200 can access via the network interface 212 includes the server computer 216. The network 214 can be any type of network or combinations of network such as a local area network or a wide-area network (e.g. an intranet, a virtual private network, or the Internet). The network interface 212 can be configured to communicate with the network 214 by any type of network protocol whether wired or wireless (or both).

The server computer 216 can be a computer system, of a conventional architecture similar, in a general sense, to that of the workstation 200, and as such includes one or more central processing units, system buses, and memory resources, network interfaces, and the like. The server computer 216 can be coupled to a program memory 218, which is a computer-readable medium that stores executable computer program instructions, according to which the processes described below can be performed. The computer program instructions can be executed by the server computer 216, for example in the form of a “web-based” application, upon input data communicated from the workstation 200, to create output data and results that are communicated to the workstation 200 for display or output by the peripheral devices 208 in a form useful to the human user of the workstation 200. In addition, a library 220 can also be available to the server computer 216 (and the workstation 200 over the network 214), and can store such archival or reference information as may be useful in the computer system 124. The library 220 can reside on another network and can also be accessible to other associated computer systems in the overall network.

Of course, the particular memory resource or location at which the measurements, the library 220, and the program memory 218 physically reside can be implemented in various locations accessible to the computer system 124. For example, these data and computer program instructions for performing the processes described herein can be stored in local memory resources within the workstation 200, within the server computer 216, or in network-accessible memory resources. In addition, the data and the computer program instructions can be distributed among multiple locations. It is contemplated that those skilled in the art will be readily able to implement the storage and retrieval of the applicable measurements, models, and other information useful in connection with implementations, in a suitable manner for each particular application.

In implementations, the bit trip calculator 128 can be configured as a software program that is capable of executing on the computer system 124. As such, the bit trip calculator 128 can include the necessary logic, algorithms, instructions, code, etc. to perform the process described herein. In implementations, the bit trip calculator 128 can be configured to simulate different scenarios on a new wellbore 102 or sections of a wellbore 102 for which drilling have not begun. For example, the bit trip calculator 128 can be configured to simulate the various scenarios for one or more sections of the new wellbore 102. The bit trip calculator 128 can also be configured to simulate, in real-time, different scenarios on a wellbore 102 in which drilling has already begun. For example, the bit trip calculator 128 can simulate the different scenarios on the section currently being drilled as well as sections to be drilled. Additionally, the bit trip calculator 128 can simulate different scenarios on a wellbore 102 that has already been completed. For example, the bit trip calculator 128 can be utilized to determine if the proper bit trip schedules and bit selections were made during drilling.

To simulate different scenarios, the bit trip calculator 128 can be configured to determine various inputs that constrain the drilling process for each section and the inputs that define the cost of drilling. FIG. 2B illustrates various inputs to and outputs from the bit trip calculator 128. As illustrated in FIG. 2B, the bit trip calculator 128 can receive or determine input data that allows the bit trip calculator 128 to simulate various scenarios for each section of the wellbore 102 and determine total cost of each of the simulated scenarios. As illustrated, the bit trip calculator 128 can receive or determine input data related to sections and intervals to be simulated (input 252), properties of the section and interval (input 254), cost of the drill bit, drilling rig, and other components (input 256), and constraints (input 258). In implementations, the inputs and data used by the bit trip calculator 128 can be programmed into the bit trip calculator 128 or contained in storage accessible by the bit trip calculator 128. Likewise, the bit trip calculator 128 can be configured to receive one or more of the inputs from a user of the bit trip calculator 128.

In implementations, the input 252 can include the number of sections to be simulated and parameters that define the intervals and sections. As discussed herein, a “section” can refer to a portion of a wellbore for which the bit trip calculator will simulate various scenarios. As discussed herein, an “interval” can refer to a discrete section of the wellbore 102. For example, an interval can correspond to one of the layers 110, 112, and 114 or a user defined interval when for example ROP is controlled due to for example drilling out a shoe, limiting ROP to obtain good quality logging data or for hole cleaning purposes. The bit trip calculator 128 can be extended to optimize for the entire well by optimizing multiple sections, each containing one or multiple intervals. In this case, some depths can be fixed points where the bit has to be pulled out of hole (because they are the end of a section, there is a planned coring point, planned change in MWD, certain formations should not be tripped in, etc.) The bit trip calculator 128 can also consider the case that a section target depth is a range. The bit trip calculator 128 can then optimize also what the best point is to call a section depth. For fixed sections each section is optimized individually and then they are all added together. If the target depth is a range then the bit trip calculator 128 simulates different target depths and computes the optimal scenarios for each of the target depths in the range.

The input 254 can include the properties of the sections and/or intervals to be simulated. The properties can include the physical composition of the sections and/or intervals, the ROP of the sections and/or intervals, and the like. The input 256 can include the cost of the drill bits, the daily cost of the drilling rig, and the cost of other components. The input 258 can include any parameters that constrain the drilling process. For example, the input 258 can include the maximum number of drill bits to use per section, the types of drill bits to simulate, the maximum time between BOP tests, and the like. Further examples of input 258 are described below. While FIG. 2B illustrates various inputs into the bit trip calculator 128, the illustrated inputs are examples and the bit trip calculator 128 can utilize any input to simulate different drill bit scenarios and calculate the total cost.

Once the bit trip calculator 128 has received or determined the inputs, the bit trip calculator 128 can simulate different bit tripping scenarios for one or more sections of the wellbore 102. In implementation, for each section, the bit trip calculator 128 can determine different scenarios based on the constraints input into the bit trip calculator 128. For example, if a max number of bits and types of drill bits are input for a section, the bit trip calculator 128 can simulate different combinations of the numbers and types of drill bits being utilized for the section. For instance, the bit trip calculator 128 can simulate the different combinations being utilized in different amounts to complete the section. For each of the different scenarios, the bit trip calculator 128 can determine the total cost of the scenario.

To determine the total cost for each of the simulated scenarios, the bit trip calculator 128 can be configured to utilize a cost model that considers cost of the bit, cost of tripping, cost of the drilling, and the cost of making connections. For example, the cost of a single bit run can be generally represented as the sum of (i) the cost of the bit, C_{b}, (ii) the cost of tripping, (iii) the cost of drilling, and (iv) the cost of making connections, where the cost of tripping/drilling/making connections is the product of the daily rig cost, C_{rig}, and the tripping time, tₜ/drilling time, t_{d}./connection time for connecting a drill bit, t_{con}. Thus, the cost of a single bit run can be given equation (1):

C=C_{b}+C_{rig}(tₜ+t_{d}+t_{con}) (1)

When describing the equations herein, the equations are presented assuming consistency of units for parameters. One skilled in the art will realize that, if variables are measured in different units then conversion factors may need to be included.

The time spent drilling, t_{d}, can be expressed as a function of the average on bottom ROP for that run, R̅O̅P̅, and the distance drilled, l, and can be given by equation (2):

$${t}_{d} = \frac{l}{\overline{ROP}} \qquad ( 2 )$$

The connection time can be given by equation (3):

$${t}_{con} = \frac{{t}_{c} l}{{l}_{c}} \qquad ( 3 )$$

where t_{c} is the time to make a single connection, l is the length of the run and l_{c} is the length of pipe after which a connection has to be made.

The tripping time generally increases in relation to the hole depth. For example, the tripping time can be proportional to the hole depth plus time to make up the BHA. Typically, the bit can be tripped in at the beginning of the run and then tripped out at the end of the run. For this, tripping time, tₜ, can be given by equation (4):

tₜ=k(dₒ+d₁)+const (4)

where d₀ is the hole depth at the beginning of the run, d₁ is the hole depth at the end of the run, k is the constant of proportionality for tripping and const is the constant time to make up the BHA. Both k and const are empirical values and thus can be computed using interval specific data, for example, tripping times from offset wells.

Substituting equations (2), (3), and (4) into equation (1) the cost of a single bit run can be expressed by equation (5):

$$C = {C}_{b} + {C}_{rig} [ k ( {d}_{0} + {d}_{1} ) + const + \frac{1}{\overline{ROP}} + \frac{{t}_{c} l}{{l}_{c}} ] \qquad ( 5 )$$

For multiple bit runs, equation (5) can be summed over each individual run, giving a total cost equation (6):

$$C = {\sum }_{i = 1}^{N} {C}_{{b}_{i}} + {C}_{rig} [ 2 {kd}_{i} + const + \frac{{l}_{i}}{\overline{{ROP}_{l}}} ] - {C}_{rig} {kd}_{N} + {C}_{rig} {kd}_{0} + {C}_{rig} \frac{{d}_{N} - {d}_{0}}{{l}_{c}} {t}_{c} \qquad ( 6 )$$

The subscript i denotes the number of the bit run and the parameters associated with that bit run. N is the total number of bit runs. The bit trip calculator 128 can utilize equation (6) for bit trips prior to drilling one or more sections or intervals or after drilling is completed. If the bit tip calculator 128 is utilized in real-time, while drilling is in progress, the bit may already be within the wellbore 102 and the last term in equation (6) may be superfluous and some of the const to account for the initial making up of the BHA is not necessary.

In addition to the cost of drilling, tripping, making connections, and the bits, the bit trip calculator 128 can also be configured to include several other operations which may add time and thus cost. In general, there are intervals during the process which are not spent drilling. The bit trip calculator 128 can consider other operations which can occur at varying frequencies. For example, these events can include logging or taking a survey, dropping a ball to activate a tool, wiper trips, and the like. In general, the additional cost will be given by C_{rig}tₑᵥₑₙₜ, where tₑᵥₑₙₜ is i the duration of the event. A user can input, into the bit trip calculator 128 an event, the duration of the event, the frequency of the event and when it is triggered (e.g. at a particular depth). Likewise, the bit trip calculator 128 can identify and retrieve the events.

Several examples are discussed below.

BOP Tests

In order to verify full functionality, BOPs have to be tested at regular intervals. During the drilling time of a wellbore a total of m BOP tests can be carried out, each requiring a time t_{BOP}. The additional cost associated with this time is C_{rig}mt_{BOP}. The number of tests necessary can be obtained from one of the constraints described herein.

Wellbore Cleaning

To provide for a clean wellbore 102, the driller may have to circulate drilling mud which takes time t_{cir}, and results in an additional cost of C_{rig}t_{cir}. The time for circulating depends on the flow rate, pipe diameter, wellbore 102 diameter, depth and the number of times which need to be circulated bottoms up at a given depth. The circulation may occur several times during the drilling of a well and all circulation operations have to be added up. Similar to circulating bottoms up wiper trips may be carried out which have the purpose of ensuring a clean good quality well bore. The time trips take can depend on the distance of the wiper trip. In this case, similar to equation (4) the time for a wiper trip is 2kd where d is the distance of the trip. And thus the overall cost this adds is 2kdC_{rig} added all over all wiper trips.

Miscellaneous Operations

In another example, the slip line may have to be cut. In this case, the user can enter, into the bit trip calculator 128, how long the event takes and the frequency. This functionality can thus also be used for other events when the bit is not moving and could even be extended to temporary downtime during drilling.

Another event in this category could be staging in for high pressure high temperature (HPHT) wells. In this case several breaks will occur during tripping or drilling to ensure that the components in the BHA 108 can be cooled appropriately by the mud. The time this takes, t_{stage} depends on the bit depth and the downhole conditions and adds a total of C_{rig}t_{stage} to the cost.

In another example, tripping speed may need to be reduced, thus reducing the coefficient of proportionality between depth and time to trip. This may be necessary to allow for swab and surge limits or it may be needed when core is pulled out of the hole, which requires a lower speed. In this example, the bit trip calculator 128 can change the coefficient of tripping, k.

There are also several other factors which can be added to the cost equation in a similar manner and improve the accuracy of the total cost equation. The bit trip calculator 128 can include each of these additional features in equation (6) if and when the application requires them. In addition to the features there are multiple constraints which may be taken into account in the total cost equation. These constraints can affect whether the simulated scenarios are viable solutions.

Sections

The depth in and depth out of the section to be drilled can be a constraint. Both depths may be fixed points or a range if flexibility is allowed.

Time Between BOP Tests

The time between two successive BOP tests cannot exceed a specified duration, t_{B}. When simulating a scenario, the bit trip calculator 128 can determine if equation (7) is satisfied:

$${\sum }_{i = j}^{n} ( 2 {kd}_{i} + const + \frac{{l}_{i}}{\overline{{ROP}_{l}}} ) + \frac{{d}_{n} - {d}_{j - 1}}{{l}_{c}} {t}_{c} - {kd}_{n} + {kd}_{j - 1} \leq {t}_{B} \qquad ( 7 )$$

where j is the first run after the previous BOP test and n is a future bit run, to be determined by this constraint. As before, for real time use the kdⱼ₋₁ term can be ignored but the time elapsed since the previous test has to be added. This constraint also puts a limit on the maximum time of a single bit run and as mentioned before from this constraint the number of BOP tests, m, can be computed.

Bearing Life

Roller cone drill bits, roller reamers and hybrid bits with bearings have a fixed life span. This is limited by the maximum number of revolutions which the bit or reamer can sustain, Kₘₐₓ (equation (8a)), and the maximum total energy, TEₘₐₓ, which the component can experience (equation (8b)). The constraint can be given by whichever out of the two occurs earlier and at this point the BHA will be pulled up to surface. Therefore, where applicable, an additional constraint is added limiting the duration for which some bits can stay in the hole. During drilling the following two inequalities both have to be satisfied:

$$\begin{matrix}{K}_{b} + \overline{{RPM}_{l}} {t}_{di} \leq {K}_{max} & ( 8 a ) \\ {TE}_{b} + \frac{{\overline{WOB}}_{i} * {\overline{RPM}}_{i} * {t}_{di}}{1000 {d}_{b}} \leq {TE}_{max} & ( 8 b )\end{matrix}$$

where K_{b} is the revolutions which the bit has undergone before the start of the run, R̅P̅M̅ᵢ is the average RPM of the tool during the run, W̅O̅B̅ₜ̅ is the average WOB of the tool during the run, TE_{b} is the total energy of the bit before the start of the run and d_{b} is the bit diameter for the run and t_{di} for a run is given by equation (8c):

$${t}_{di} = \frac{{l}_{i}}{{\overline{ROP}}_{i}} \qquad ( 8 c )$$

However, it can also be the case that roller reamers are run with, for example, a PDC bit. A PDC bit usually has no bearings so this functionality would allow users to enter a bearing life even for bits without bearings if necessary.

Fixed Events

As described above, the bit trip calculator 128 can optimize the simulated scenarios based on BOP tests: For example, a BOP test is scheduled to happen every x days or x hours. The bit trip calculator 128 can incorporate other fixed events in this constraint.

For example, a particular BHA can have a given lifetime and need to be pulled after a fixed time period. This event can occur for the particular tools in the wellbore 102. The bit trip calculator 128 can utilize this constraint in the simulated bit tripping scenarios. For example, the bit trip calculator 128 can utilize a model having a fixed battery lifetime of one of the components in the BHA 108 or a fatigue limit of BHA 108 components. This can be given by equation (9):

$$time = ellapsed time + \frac{{l}_{i}}{{ROP}_{i}} + \frac{{t}_{c} ( {d}_{i} - {d}_{i - 1} )}{{l}_{c}} + {d}_{i} k + {d}_{i - 1} k \qquad ( 9 )$$

Note, the last three terms may not always be necessary, for example, the battery may only be used during drilling.

The bit trip calculator 128 can also utilize a constraint of having to trip the drill string 104 at a particular time as a one off event and not linked to a particular BHA 108. Following this trip is a fixed, user defined downtime. Unlike the BOP test, this does not happen on a regular basis. This can for example mimic that the rig has to be shut down for weather. This could be given by equation (10):

$$time = {\sum }_{i = j}^{n} ( \frac{{l}_{i}}{{ROP}_{i}} + 2 {d}_{i} k + const ) + \frac{{t}_{c} ( {d}_{n} - {d}_{j - 1} )}{{l}_{c}} - {d}_{n} k + {d}_{j - 1} k \qquad ( 10 )$$

This has to be less than the time until the event. Then, the downtime is given by:

Downtime=duration of event+time of event−time of BHA pulled

Tripping Time

As described above, the tripping time can be included as a linear function of the current bit depth. The bit trip calculator 128 can include further extensions which improve accuracy of the trip time. For example, there can be events during which the bit is stationary. For instance, one example is circulating before tripping to ensure the hole is clean. This is usually done before the trip and is dependent on the flow rate and the bit depth. As a rule two circulations can be included in the model. However, should the user wish to change the number of times or the depths (multiple depths possible) at which this occurs then that can be done. Similar to functionality 3, time of one circulation bottoms up can be given by equation (11):

$${time}_{{bottoms}_{up}} = \frac{{l}_{i} {π ( \frac{ID}{2} )}^{2}}{Q} + \frac{{l}_{i} {π ( \frac{HD - OD}{2} )}^{2}}{Q} \qquad ( 11 )$$

where ID is internal diameter of pipe, OD is external diameter of pipe, HD is hole diameter and Q is the flow rate.

In another example, there can be a need for the slip line may to be cut. In this case, the user can enter, into the bit trip calculator 128, how long the event takes and the frequency. This functionality can thus also be used for other events when the bit is not moving and could even be extended to temporary downtime during drilling. Another event in this category can be staging in for HPHT wells. In this case several breaks will occur during tripping to ensure that the components in the BHA 108 can be cooled appropriately by the mud.

In another example, tripping speed may need to be reduced, thus reducing the coefficient of proportionality between depth and time to trip. This may be necessary to allow for swab and surge limits or it may be needed when core is pulled out of the hole, which requires a lower speed. In this example, the bit trip calculator 128 can change of coefficient of tripping, k.

While various examples of constraints have been discussed above, the bit trip calculator 128 can be configured to consider any constraints that can affect the total cost of drilling.

As discussed above, the cost equation, additional features, and constraints are utilized by the bit trip calculator 128 to simulate different bit tripping scenarios and determine the total cost of each. Another factor that can be configured in the bit trip calculator 128 is ROP. For example, the bit trip calculator 128 can utilize an average ROP for an interval. The average ROP can be determined from data collected from offset wells. Likewise, for example, the bit trip calculator 128 can be configured to estimate future ROP. The bit trip calculator 128 can be configured to predict ROP based on known theoretical models or artificial neural networks. The bit trip calculator 128 can be configured such that the user can input the predicted ROPs for each interval in each section. This can allow the user to decide which method for estimating ROP is the most appropriate. By allowing the section to be defined intervals as well as formations, the user can limit ROP when needed, for example when breaking in a bit, managing hole cleaning or ensuring good quality logging data.

The user can limit the ROP for a defined interval. This interval can be within one formation or over several formations. The applicability of this is for example when drilling out a shoe at the beginning of a new section (new bit size) or for example limiting ROP for good log data quality. In this example, the bit trip calculator 128 can define a separate interval to be considered where ROP is limited.

The user can also split between fresh and dull ROPs for each section or interval and bit. For example, the bit trip calculator 128 can receive from the user when the model should transition between the new and dull ROPs given by the length for which the bit remains sharp has to be entered. This length may be tied to a particular formation or be an absolute length. ROPs can be entered for different bit types and thus the model can help identify what type of bit to use and whether a new bit or a previously used (re-run) bit is more economical.

For real time applications, the bit trip calculator 128 can be configured to determine the current ROP, which can be fed into the model. For example, the bit trip calculator 128 can acquire data from the drilling sensors 109 of the drill string 104 and BHA 108. Based on the current ROP, the bit trip calculator 128 can adjust ROP for future intervals can be adjusted according to the current wear state of the bit.

There may be a percentage chance of hitting a trouble zone. In this case the tool would optimize both for the case of hitting this zone and for the case of not hitting this zone. Associated with a trouble zone is a lower ROP and more downtime. The bit trip calculator 128 can make calculations for hitting a trouble zone and the case of not hitting it.

The bit trip calculator 128 can also benchmark ROP performance. For example, the bit trip calculator 128 can compare the current ROP to the expected ROP. The tool displays differences between current and estimated ROPs and can alert when performance is suboptimal. Suboptimal performance may be due to premature wear of the bit, drilling dysfunctions or sub optimal drilling parameters. The bit trip calculator 128 can alert the driller to review the parameters and situation and identify the cause of the poor performance.

Returning to FIG. 2B, once the bit trip calculator 128 simulates the scenarios and calculates the total cost of each, the bit trip calculator 128 can output various data for evaluation. As illustrated in FIG. 2B, the bit trip calculator 128 can output a recommendation of number and types of drill bits to use (output 262), a recommendation of when to trip the drill bit (output 264), a recommendation of when to carry out BOP tests, total cost of drilling (output 266), and a benchmarking ROP compared to expected ROP (output 268). The bit trip calculator 128 can be configured to output the information in any type of format. For example, the bit trip calculator 128 can be configured to generate a graphical user interface (GUI) that displays the information to a user. The bit trip calculator 128 can also be configured to store any of the outputs or inputs to the bit trip calculator 128. While FIG. 2B illustrates various inputs into the bit trip calculator 128, the illustrated outputs are examples and the bit trip calculator 128 can output any data relevant to the simulated scenarios and output the data in any format.

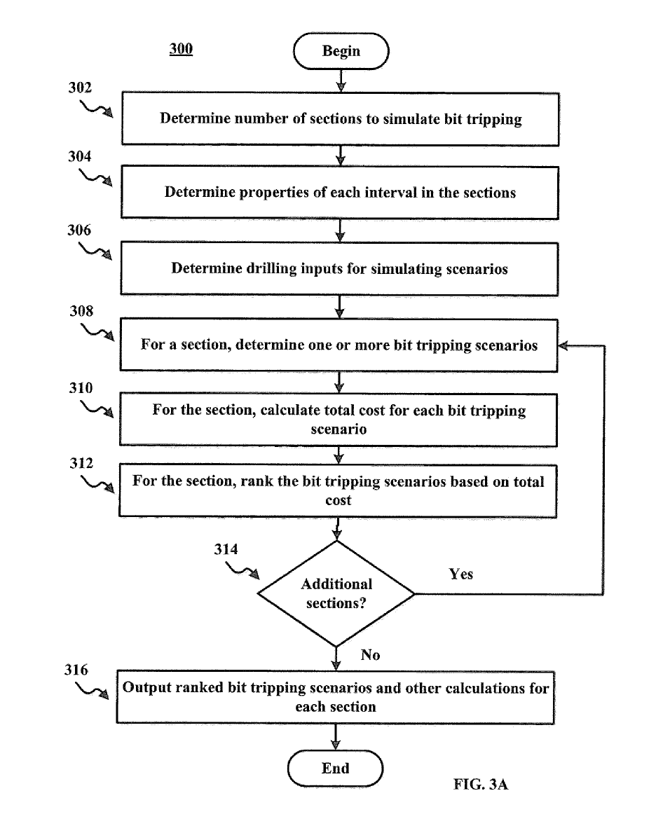

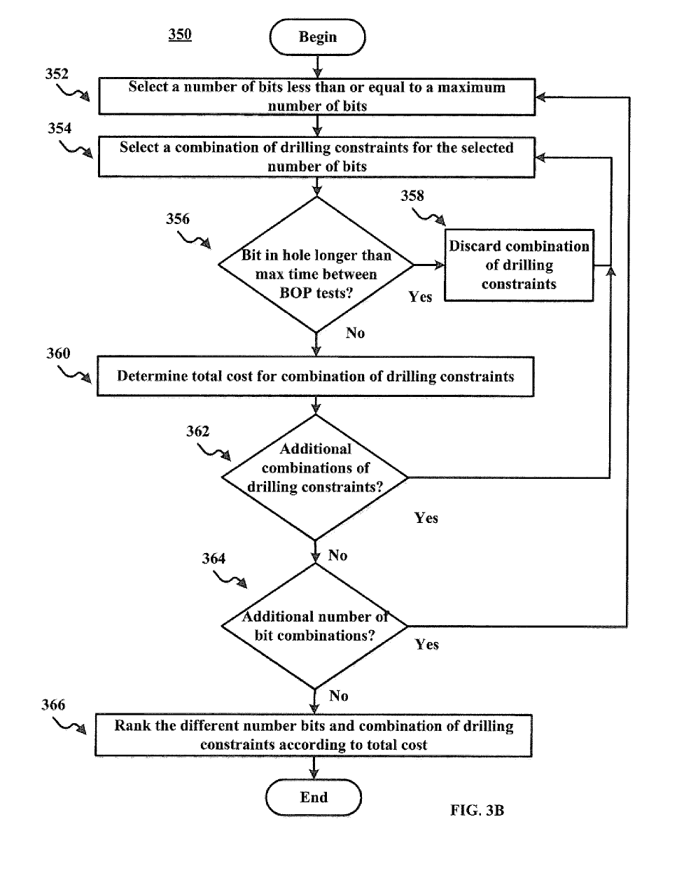

Described below are several examples of processes that can be performed by the bit trip calculator 128 for optimizing bit tripping, according to various implementations. FIG. 3A illustrates an example of a process 300 for a bit trip scenario that minimizes total cost, according to various implementations. While FIG. 3A illustrates various processes that can be performed by the bit trip calculator 128 miming on the computer system 124, any of the processes and stages of the processes can be performed by any component of the computer system 124 or the drilling system 100. Likewise, the illustrated stages of the processes are examples and any of the illustrated stages can be removed, additional stages can be added, and the order of the illustrated stages can be changed.

After the process begins, in 302, the bit trip calculator 128 can determine the number of sections to simulate bit tripping scenarios. The sections can correspond to one or more intervals of the wellbore 102. Likewise, the sections can correspond to any beginning and target depth in the wellbore 102. The bit trip calculator 128 can be configured to automatically simulate bit tripping for all the sections or intervals remaining in the wellbore 102. For example, the bit trip calculator 128 can be utilized prior to drilling, and the bit trip calculator 128 can simulate bit tripping scenarios for each section or interval in the wellbore 102. Likewise, for example, if the bit trip calculator 128 is utilized during active drilling, the bit trip calculator 128 can simulate bit tripping scenarios for the section currently being drilled and any remaining sections or intervals. Additionally, the bit trip calculator 128 can be utilized after drilling of one or more sections is completed to evaluate the already drilled sections.

Additionally, the bit trip calculator 128 can be configured to receive the number of sections to simulate from a user. The bit trip calculator 128 can also be configured to receive the parameters of each of the sections (e.g., beginning and ending positions of a section). For example, the bit trip calculator 128 can provide a user interface to the user for selection of sections to simulate bit tripping scenarios.

In 304, the bit trip calculator 128 can determine properties of each interval of the sections for which bit tripping scenarios will be simulated. The properties of each interval can include the physical properties, such as the materials contained in each interval. Likewise, the properties of each interval can include relevant information concerning drilling in the interval, for example, the ROP for the interval by different drill bits. One or more of the properties of each interval can be maintained and retrieved by bit trip calculator 128. Likewise, one or more of the properties can be input by a user of the bit trip calculator 128.

In 306, the bit trip calculator 128 can determine the drilling inputs for simulating bit tripping scenarios. The bit trip calculator 128 can determine any relevant information necessary for simulating the bit tripping scenarios. The relevant information can include any information that affects the tripping of the drill string 104 and the total cost of drilling. For example, the bit trip calculator 128 can determine any of the relevant functionality and constraints as discussed above in FIG. 2B.

Once the bit trip calculator 128 has determined the properties of each interval and the inputs, the bit trip calculator 128 can determine, for each section, different bit tripping scenarios based on the drilling inputs. The bit trip calculator 128 can then calculate the total cost for each scenario and determine the scenario that has the lowest total cost.

Continuing with FIG. 3A, in 308, the bit trip calculator 128 can determine, for a particular section, different bit tripping scenarios. For example, for a given maximum number of bits for a section, the bit trip calculator 128 can simulate different scenarios for different numbers of bits up to the maximum number of bits. That is, for each possible number of bits, the bit trip calculator 128 can simulate different bit tripping scenarios. For each possible number of bits, the bit trip calculator 128 can simulate different possible usages of the bit. The bit trip calculator 128 can simulate the usage amounts based on time in the wellbore 102 for each bit, length to be completed by each bit, percentage of section completed by each bit, etc.

Additionally, the bit trip calculator 128 can simulate different scenarios for different types of drill bits. For example, the bit trip calculator 128 can simulate, for each type of drill bit, different scenarios for different number of bits up to the maximum number of bits. Additionally, the bit trip calculator 128 can simulate different scenarios in which different types of drill bits are utilized in the same scenario. That is, for each possible number of bits and drill bit types, the bit trip calculator 128 can simulate different bit tripping scenarios.

For example, if the bit trip calculator 128 determines a maximum number of bits is two (2) bits, the bit trip calculator 128 can simulate scenarios where 1 bit is utilized and can simulate scenarios where 2 bits are utilized.

When simulating the different scenarios, the bit trip calculator 128 can also eliminate various simulated scenarios based on constraints of the drilling process as described above in FIG. 2B. For example, the drilling system 100 can have a safety or regulatory constraint that the drilling system be tested after a specific amount of time in use. The bit trip calculator 128 can eliminate any simulated scenarios that require the drill string 104 remain in the wellbore longer than the time constraints.

In 310, for the particular section, the bit trip calculator 128 can determine a total cost for each of the simulated bit tripping scenarios. For each simulated section, the bit trip calculator 128 can utilize equation (6) to determine the total cost for each of the simulated bit tripping scenarios. Additionally, the bit trip calculator 128 can include, in equation (6), any relevant additional cost factors, for example, cost factors described above in FIG. 2B.

In 312, for the particular section, the bit trip calculator 128 can rank the simulated bit tripping scenarios based on the total cost for each scenario. The bit trip calculator 128 can be configured to rank the simulated bit tripping scenarios so that the lowest cost scenario receives the highest rank.

In 314, the bit trip calculator 128 can determine if there are additional sections to simulate bit tripping. If the bit trip calculator 128 determines there are additional sections, the bit trip calculator 128 returns to stage 308 and repeats the process for the additional sections. If all the sections have been simulated, the bit trip calculator 128 proceeds to stage 316.

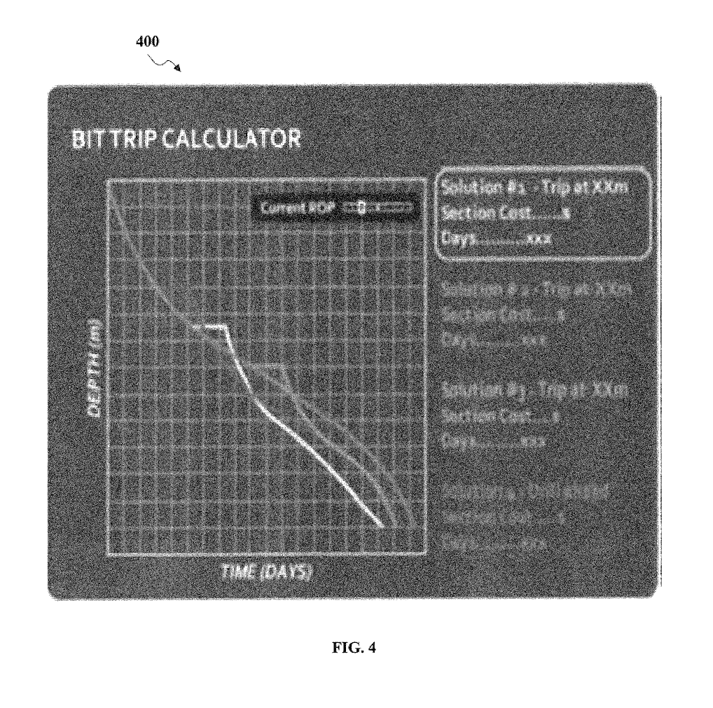

In 316, the bit trip calculator 128 can output the ranked bit tripping scenarios and other calculations for each section. The bit trip calculator 128 can output any relevant information useful to the drilling process, for example, information described above in FIG. 2B. For example, FIG. 4 illustrates an output from the bit trip calculator 128. As illustrated in FIG. 4, the bit trip calculator 128 can display a graph progress of the drilling. The bit trip calculator 128 can also display the top ranked tripping scenarios including details of the scenarios, such as the next time to trip, time of next BOP test, the total cost of the section, and the total time for the section.

FIG. 3B illustrates a more detailed example of a process 350 that can be utilized to perform stages 308-316 including a constraint of a maximum number of drill bits per section and BOP test described above, according to various implementations. While FIG. 3B illustrates various processes that can be performed by the bit trip calculator 128 running on the computer system 124, any of the processes and stages of the processes can be performed by any component of the computer system 124 or the drilling system 100. Likewise, the illustrated stages of the processes are examples and any of the illustrated stages can be removed, additional stages can be added, and the order of the illustrated stages can be changed.

In the process 350, the bit trip calculator 128 calculates the total cost for all scenarios of different numbers of drill bits less than and equal to the maximum number of drill bits and does not violate the time between BOP tests. The process 350 is described below with reference to a single section being drilled. The process 350, however, can be repeated multiple times for different sections as described in reference to FIG. 3A.

In 352, the bit trip calculator 128 can select a number of drill bits less than or equal to the maximum number of drill bits for a section. For example, the bit trip calculator 128 has determined, for a particular section, a maximum of three (3) drill bits. The bit trip calculator 128 can first select one (1) drill bit to simulate bit tripping scenarios. The bit trip calculator 128 can also select one or more types of drill bits to simulate for a section.

In 354, the bit trip calculator 128 can select a combination of drilling constraints for different scenarios for the selected number of drill bits. The bit trip calculator 128 can select drilling constraints of what percentage each drill bit is used to complete the section of the wellbore 102. For instance, in the 1 drill bit example described above, the bit trip calculator 128 can select that the 1 drill bit will be used for 100% of the section. In another example, with a selected number of drill bits being two (2), the bit trip calculator 128 can select that each of the two drill bits will be used to complete 50% of the section.

In 356, the bit trip calculator 128 can determine if the selected combination of drilling constraints violates the maximum time between BOP tests. The bit trip calculator 128 can determine, based on the ROP, how long each drill bit will be in the wellbore 102. The bit trip calculator 128 can compare the time each bit will be the wellbore 102 to the maximum time between BOP tests. The drill bit calculator 128 can utilize equation (7) depending upon whether the section being simulated is to be drilled or currently being drilled.

If the time of any of the bits will be in the wellbore for is longer than the maximum time between BOP tests, in 358, the bit trip calculator 128 can discard the selected combination of drilling constraints for the scenario. For instance, in the 1 bit example, the bit trip calculator 128 can determine that it will take 1 bit, 350 hours to complete a section, but the maximum time between BOP tests is 336 hours. In this example, the bit trip calculator can discard the 1 bit combination of 100 percent drilling the section.

In 360, if the time of any of the bits will be in the wellbore 102 does not violate the maximum time between BOP tests, the bit trip calculator 128 can determine the total cost for the selected drilling constraints for the scenario. The bit trip calculator 128 can determine the total cost based on all the individual costs for drilling a section. The bit trip calculator 128 can utilize equation (6) that includes a term for the cost of the BOP test. For example, the term for cost of the BOP test can be based on the equation (12):

Cost of BOP test=C_{rig}t_{BOP}m (12)

where C_{rig} is the rig cost, t_{BOP} is the time to perform a BOP test; m is the number of BOP tests.

In 362, the bit trip calculator 128 can determine if there are additional combinations of drilling constraints for a scenario to simulate. If no additional combination exists, the bit trip calculator 128 can proceed to 364. For example, in the 1 bit example, the bit trip calculator 128 can determine only one combination exists (100%) drilling the entire section. If the bit trip calculator 128 determines additional combinations of drilling constraints exist, the bit trip calculator 128 can repeat stage 354-360 for the different combination of drilling constraints for the scenarios. For instance, in the 2 bit example, the bit trip calculator 128 can test other combinations of drilling constraints (usage), such as 5% for first bit, 95% for the second bit, 10% for the first bit, 90% for the second bit, etc.

In 364, the bit trip calculator 128 can determine if there are additional numbers of bit combinations or additional types of drill bits to simulate. If not, the bit trip calculator 128 can proceed to 366. If additional numbers of bit combinations or additional types of drill bits to simulate exist, the bit trip calculator 128 can repeat stages 352-362 for the additional number of bit combinations. For instance, in the 3 bit maximum example, the bit trip calculator 128 can perform stage 352-362 for 1 bit, 2 bits, and 3 bits. As described above, for each of the 1 bit, 2 bits, and 3 bits, the bit trip calculator 128 can calculate the total cost for each combination of drilling constraints for the scenarios for each of the 1 bit, 2 bits, and 3 bits selected.

In 366, once all the numbers of bits and combination are determined, the bit trip calculator 128 can rank the results based on the total cost of each. The bit trip calculator 128 can rank the results in order based on minimum total cost receiving the highest ranking.

FIG. 3B describes an example of the functionality of the bit trip calculator 128 and the constraints for simulating bit tripping scenarios. As discussed above, additional functionality and constraints can be incorporated in the bit trip calculator 128.

Certain implementations described above can be performed as a computer application or program. The computer program can exist in a variety of forms both active and inactive. For example, the computer program can exist as one or more software programs, software modules, or both that can be comprised of program instructions in source code, object code, executable code or other formats; firmware program(s); or hardware description language (HDL) files. Any of the above can be embodied on a computer readable medium, which include computer readable storage devices and media, and signals, in compressed or uncompressed form. Examples of computer readable storage devices and media include conventional computer system RAM (random access memory), ROM (read-only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the present teachings can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A computer-implemented method for optimizing drilling, the method comprising:
determining at least one section of a wellbore for which to determine a schedule for replacing one or more drill bits during drilling the wellbore in real-time while drilling the wellbore is in progress;
determining one or more constraints on the schedule for replacing the one or more drill bits;
determining, based on the one or more constraints, a plurality of scenarios for replacing the one or more drill bits during drilling the at least one section;
determining, by one or more processors, a total cost for each scenario in the plurality of scenarios; and
identifying at least one scenario in the plurality of scenarios that has the lowest cost compared to other ones of the plurality of scenarios.

2. The computer-implemented method of claim 1, wherein the at least one section comprises at least one of:
an interval of the wellbore corresponding to a layer of earth; and
an interval of the wellbore defined by a upper location in the wellbore and a lower location in the wellbore.

3. The computer-implemented method of claim 2, wherein the total cost for each scenario in the plurality of scenarios comprises a cost of each of the one or more drill bits determined for the scenario and a cost of a drilling rig over a period of time to drill the wellbore according to the scenario.

4. The computer-implemented method of claim 3, wherein the total cost for each scenario in the plurality of scenarios further comprises a cost associated with the one or more constraints.

5. The computer-implemented method of claim 4, wherein the one or more constraints comprises at least one of a maximum number of drill bits for the at least one section and at least one type of drill bit for the at least one section.

6. The computer-implemented method of claim 5, wherein determining, based on the one or more constraints, the plurality of scenarios comprises:
determining the plurality of scenarios such that each scenario in the plurality of scenarios comprises:
a different number of drill bits to use to drill the at least one section which is less than or equal to the maximum number of the drill bits, or
a different amount of time to use the one or more drill bits to drill the at least one section.

7. The computer-implemented method of claim 6, wherein determining, based on the one or more constraints, the plurality of scenarios comprises:
determining the plurality of scenarios such that each scenario in the plurality of scenarios comprises:
a different number of drill bits to use to drill the at least one section which is less than or equal to the maximum number of the drill bits,
a different amount of time to use the drill bits to drill the at least one section, or
one of the at least one type of drill bit to use to drill the at least one section.

8. The computer-implemented method of claim 1, wherein the one or more constraints comprise a time limit that the one or more drill bits can be within the wellbore before being removed.

9. The computer-implemented method of claim 8, wherein the time limit corresponds to a maximum time between blowout preventer tests.

10. The computer-implemented method of claim 8, the method further comprising:
discarding one or more of the plurality of scenarios in response to the one or more drill bits being within the wellbore longer than the time limit.

11. The computer-implemented method of claim 1, wherein the one or more constraints comprise an event that requires the one or more drill bits to be removed from the wellbore and wherein the total cost for each scenario in the plurality of scenarios comprises a cost of each of the one or more drill bits determined for the scenario, a cost of a drilling rig over a period of time to drill the wellbore according to the scenario, and a cost associated with the event.

12. The computer-implemented method of claim 1, the method further comprising:
determining a rate of penetration for the one or more drill bits.

13. A system for optimizing drilling, the system comprising:
one or more memory devices storing instructions; and
one or more processors configured to execute the instructions to perform a method comprising:
determining at least one section of a wellbore for which to determine a schedule for replacing one or more drill bits during drilling the wellbore in real-time while drilling the wellbore is in progress;
determining one or more constraints on the schedule for replacing the one or more drill bits;
determining, based on the one or more constraints, a plurality of scenarios for replacing the one or more drill bits during drilling the at least one section;
determining a total cost for each scenario in the plurality of scenarios; and
identifying at least one scenario in the plurality of scenarios that has the lowest cost compared to other ones of the plurality of scenarios.

14. The system of claim 13, wherein the total cost for each scenario in the plurality of scenarios comprises a cost of each of the one or more drill bits determined for the scenario, a cost of a drilling rig over a period of time to drill the wellbore according to the scenario, and a cost associated with the one or more constraints.

15. The system of claim 14, wherein the one or more constraints comprises at least one of a maximum number of drill bits for the at least one section and at least one type of drill bit for the at least one section.

16. The system of claim 15, wherein determining, based on the one or more constraints, the plurality of scenarios comprises:
determining the plurality of scenarios such that each scenario in the plurality of scenarios comprises:
a different number of drill bits to use to drill the at least one section which is less than or equal to the maximum number of the drill bits, or
a different amount of time to use the one or more drill bits to drill the at least one section.

17. The system of claim 15, wherein determining, based on the one or more constraints, the plurality of scenarios comprises:
determining the plurality of scenarios such that each scenario in the plurality of scenarios comprises:
a different number of drill bits to use to drill the at least one section which is less than or equal to the maximum number of the drill bits,
a different amount of time to use the one or more drill bits to drill the at least one section, or
one of the at least one type of drill bit to use to drill the at least one section.

18. The system of claim 13, wherein the one or more constraints comprise a time limit that the one or more drill bits can be within the wellbore before being removed and wherein the one or more processors is configured to execute the instructions to perform the method further comprising:
discarding one or more of the plurality of scenarios in response to the one or more drill bits being within the wellbore longer than the time limit.

19. The system of claim 15, wherein the one or more constraints comprise an event that requires the one or more drill bits to be removed from the wellbore and wherein the total cost for each scenario in the plurality of scenarios comprises a cost of each of the one or more drill bits determined for the scenario, a cost of a drilling rig over a period of time to drill the wellbore according to the scenario, and a cost associated with the event.

20. The system of claim 15, wherein the one or more processors is configured to execute the instructions to perform the method further comprising:
determining a rate of penetration for the one or more drill bits.
